(19) United States
(12) Patent Application Publication
(10) Pub. No.: US 2012/0290221 A1
(43) Pub. Date: Nov. 15, 2012

(54) SYSTEM AND METHOD FOR MEASURING GHG EMISSIONS ASSOCIATED TO BIOPRODUCT INDUSTRY

(75) Inventors: Ricardo ARJONA ANTOLIN, Sevilla (ES); Maria de las Nieves Valenzuela Romero, Sevilla (ES); Beatriz Alonso Martinez, Madrid (ES); Raquel Diaz Molist, Madrid (ES); Rocio Garcia Encinas, Sevilla (ES); Maria Angeles Gutierrez Montero, Sevilla (ES); Jesús Yañez Vidal, Sevilla (ES); Laura Montes Garcia, Sevilla (ES); Jesús Lopez Lopez, Sevilla (ES); Macarena Marquez Piñuela, Sevilla (ES)

(73) Assignee: ABENGOA BIOENERGIA NUEVAS TECNOLOGIAS, S.A., Sevilla (ES)

(21) Appl. No.: 13/165,878

(22) Filed: Jun. 22, 2011

(30) Foreign Application Priority Data
May 9, 2011 (EP) 11382135.9

(51) Int. Cl. G06F 19/00

(52) U.S. Cl. 702/24

(57) ABSTRACT

The method & system hereby described allows the measuring of GHG emissions produced during the generation of bioproduct from different source materials. The method comprises capturing, processing and handling different parameters and data related to GHG emissions associated to every single process needed to produce bioproduct and the delivery of said bioproduct and/or source material to be transformed into said bioproduct, in order to generate a total GHG emissions value by means of applying formulae to the captioned and processed isolated data referred to GHG emissions of every process.

### CROSS REFERENCE TO RELATED APPLICATION

This application claims priority upon European Application No. EP11382135.9, filed May 9, 2011. This application is hereby incorporated by reference in its entirety for all of its teachings.

### FIELD OF THE INVENTION

The invention hereby disclosed is related to the field of sustainability and environmental control in bioproduct production processes.

The objective of this procedure is a system and method for measuring GHG emissions associated to bioproduct industry.

### BACKGROUND

Bioproducts include building materials, pulp and paper, forest products, biofuels, bioenergy, starch-based and cellulose-based ethanol, bio-based adhesives, biochemicals, biodegradable plastics, etc. ^{B}ioproducts are active subjects of research and development, and these efforts have developed significantly since the turn of the 20/21st century, mainly driven by the environmental impact of petroleum use. Bioproducts derived from bioresources can replace much of the fuels, chemicals, plastics etc. that are currently derived from petroleum. For example bioenergy is sort of bioproduct which provides a renewable energy source made available from materials derived from biological sources and includes: biofuels, bioliquids, biogas, renewable electrical energy and renewable thermal energy. In its most narrow sense it is a synonym to biofuel, which is fuel derived from biological sources. In its broader sense it includes biomass, the biological material used as a biofuel, as well as the social, economic, scientific and technical fields associated with using biological sources for energy. This is a common misconception, as bioproduct is the energy extracted from the biomass, as the biomass is the fuel and the bioproduct is the energy contained in the fuel.

Biomass is any organic material which has stored sunlight in the form of chemical energy. As a fuel it may include wood, wood waste, straw, manure, sugarcane, and many other byproducts from a variety of biological processes.

There is a slight tendency for the word bioproduct to be favoured in Europe compared with biofuel in North America; bioproduct means renewable energy obtained from biological materials, and includes, among others: biofuels, bioliquids, biogas, renewable electrical energy, renewable thermal energy, chemicals, bioplastics and resins.

As an example of bioproduct, biofuels are gaining increased public and scientific attention, driven by factors such as oil price spikes, the need for increased energy security, and concern over greenhouse gas emissions from fossil fuels. Biofuels are used among others for ETBE production (gasoline additive), or for direct blending with gasoline or diesel. Being renewable energy sources, biofuels reduce CO2 emissions, and contribute to the security and diversification of the energy supply, while reducing the dependency on fossil fuels in the transportation and helping towards compliance with the Kyoto Protocol.

Greenhouse gases (sometimes abbreviated GHGs) are gases in an atmosphere that absorb and emit radiation within the thermal infrared range being the fundamental cause of the greenhouse effect. The primary greenhouse gases in the Earth's atmosphere are carbon dioxide, methane, nitrous oxide, among others.

Therefore it seems to be clear that bioproduct may be used as a alternative for other fossil fuel derived; thus producing less GHG, but it needs to be known how much GHG does the production of said bioethanol involves, in order to determine whether the use of bioproduct instead other fossil fuels could benefit the reduction of emissions affecting global warming, hence it needs to be able to accurately calculate a GHG emission level associated to the entire process of producing said bioproduct, being said GHG emission level derived from the GHG emissions related to every single process used for the transformation of raw materials.

### SUMMARY OF THE INVENTION

The object of the invention is a system and method for calculating GHG emissions associated to bioproduct industry. Said method measures not only CHG emissions related to the production itself, but as the skilled person would appreciate, logistics and transportation for both the raw material, namely source material; and final product, namely bioproduct, should be accounted. It's worth mentioning that the object of the invention applies for different source material like: cereals (corn, wheat, barley, sorgho, milho . . . ), sugar cane, straw, energy crops, forestry material, forestry residues, organic waste, wine alcohol, aquaculture and fishery residues and oleaginous crops.

The system of the invention uses data captioned from a plurality of sensors and capturing means which are connected to data transmission means and arranged along the bioproduct production plant, at logistics facilities and transportation means used to deliver either source material to the production plant or the bioproduct, once produced, from said production plant. Said captioned data may comprise information, figures, statistics and pure information related to variables associated to GHG emissions of each element where at least one sensor is allocated.

The data captioned is then sent through the data transmission means to at least one database accessible by an emissions modelling module which may comprise a processing unit, said processing unit may be embedded in the analysis and processing module o might be a standalone processing unit connected to said analysis and processing module in order to work together. As the skilled person would acknowledge said processing unit and emissions modelling module need at least storage means and memory, these two parts may be comprised in the processing unit, thus shared with the emissions modelling module; furthermore the database or databases might be stored at said storage means; but the storage means may be external or even networked storage means accessible by the processing unit and/or the emissions modelling module.

The data captioned is processed in order to get individual emission factors related to each activity, task, process or element involved in the transformation of the source material into bioproduct (including transportation and logistics, as stated above). The results of said procedure deliver individual emission factors which may be stored at the database for further actions or may be directly processed by the emissions modelling module in order to get a total GHG emissions value.

The processing unit runs the instructions needed to perform all the processes needed to get the method of the invention, which covers at least two main parts of bioproduct industry. Said instructions might be embodied as software stored at the storage means or directly, maybe temporally, at the memory of the system, waiting to be called and executed.

Said instructions allow the system to accomplish the method of the invention, which mainly comprises two parts.

The first part covers bioproduct production processes involved in bioproduct production itself, carried out at the production plants, this first part involves measuring GHG emissions linked to:
Generation of own consumed energy needed at the production plants in order to carry out the processes needed to transform the source material into bioproduct being said energy produced in terms of electricity (partly self-consumed and exported) and steam in CHP using NG as fuel. The exhaust gases are also considered by their energy content.
Bioproduct conversion processes, along the production processes needed to convert the source material into bioproduct and its co-product the common processes are identified as those previous to the separation of product and co-product. These are listed as: milling, mashing, cooking, liquefaction, fermentation, distillation de-hydration, boiler, cogeneration unit, gas turbine, steam turbine, feedstock preparation, biomass pre-treatment, solid/liquid separation, gasification, cooling, gas cleaning, compression, catalysis reaction, enzymatic hydrolisys, selexol, transesterification, evaporation, mixing, drying, stripping, degumming, filtration, recovery, refining, purification, clarification, acid esterification, condensation, vents, and rectification.

Furthermore the method hereby described may also consider processes over bioproduct co-products when associated to those processes needed to obtain the co-product of the bioproduct production at the required sell conditions (as pellets and with a defined humidity). Said co-products produced along with the bioproduct may be pure waste products resulting from obtaining the bioproduct such as sewage water or may be valuable products like DDGS (Destilled Dry Grains with Solubles) which would need individual treatments like: solid/liquid separation, evaporation, drying process, pelletization; or said co-product may be a valuable product produced along with the bioproduct. In both cases emissions are produced and are thus duly accounted.

Different co-products may be considered, such as, among others: biofuels; bioliquids; biogas; chemicals; feed raw; renewable electrical energy, renewable thermal energy; bioplastics; resins and CO₂.

Different tasks are considered under the previously defined stages, in all of them the energy and raw material consumption, as well as the wastes generation and will be perfectly identified and calculated.

GHG emissions associated with the entire bioproduct production process can be calculated according to the following formula, for the “n” previously identified steps:

$${Emissions}_{Taski} = {\sum }_{i = 1}^{n} ( {ActivityData}_{i} \cdot {EmissionFactor}_{i} )$$

In which:
Activity data is a characteristic parameter of the activity or tasks of the equipment, installations, processes or vehicles associated with a given source, which allows determining their emissions for a given period through calculation. Examples of activity data are the fuel consumption, the consumption of raw material, the distance covered by vehicles, etc. The value of each activity data could vary in each production plant and the case of use of defined raw material type. The resulting activity data for a defined subtask could be composed by a combination of several variables and constant factors.
Emission Factor is a parameter that indicates the quantity of a particular contaminant emitted from a particular activity by unit of product, volume, duration, quantity of raw material or fuel etc, and that is by unit of what has been designated as “activity data”. The value of each emissions factor could vary in each production plant and the case of use of defined raw material type.

The second part covers every GHG emission related to transportation and logistics of the source material and/or the bioproduct produced from said source material.

Greenhouse gas emissions (GHG emissions) related to bioproduct industry is calculated from the data previously captioned or collected using the collecting means and/or different sensors. The calculation is carried out by using the following data total emissions from the production of bioproduct and TDER (Transport and Distribution emissions Rate). Said Emissions from transport and distribution, etc, include emissions from the transport and storage of source material and semi-finished materials and from the storage and distribution of finished materials, namely bioproduct, related to GHG (greenhouse gas) emissions produced by the at least one transportation means resulting from processing the at least one first variable related to GHG (greenhouse gas) emissions produced by said at least one transportation means.

Hence, the method of the invention allows the measurement of the amount of GHG emissions associated to bioproduct industry, starting from the source material, taking into account the transportation to the production plant, the processes carried out at the production plant, and the emissions produced during the delivery and distribution of the bioproduct produced at said production plant.

As will be explained below in greater detail, the amount of GHG (greenhouse gas) emissions is calculated by adding up the GHG (greenhouse gas) emissions corresponding to the transportation and delivery and the GHG (greenhouse gas) emissions corresponding to the production of bioproduct.

According to what has been described above, the system of the invention comprises:
at least a processing unit adapted to at least execute instructions related to the determination of GHG (greenhouse gas) emissions level in bioproduct industry,
data collecting means adapted to collect and report at least one first variable related to GHG (greenhouse gas) emissions generated by at least one transportation means intended to deliver bioproduct and/or source material to be transformed in bioproduct,
at least one route system associated to the at least one transportation means, for showing information relating to possible transportation routes, and allowing the selection of one route, and allowing, on the basis of said information, the selection of one route, which is considered the optimal route according to preset criteria,
a plurality of sensors, arranged along a bioproduct production site, adapted to monitor, collect and report at least one second variable related to GHG (greenhouse gas) emissions generated from the production of bioproduct at said bioproduct production site,
data transmission means adapted to transmit data and connected to the processing unit and at least to the plurality of sensors,
at least one database accessible by the processing unit by means of the data transmission means, and
a GHG (greenhouse gas) emissions modelling module, connected to the processing unit and adapted to process the at least one first and second variables related to GHG (greenhouse gas) emissions, for calculating GHG (greenhouse gas) emissions data associated to each process related to bioproduct industry.

The data regarding the at least one second variable related to GHG (greenhouse gas) emissions generated from the production of bioproduct at the production site collected by the plurality of sensors located at the production site and the at least one first variable related to GHG (greenhouse gas) emissions generated by at least one transportation means, may preferably be included in the at least one database.

The plurality of sensors are preferably adapted to monitor and report data selected from the group consisting of a flow rate, temperature, pressure, weight, moisture, flow composition, energy exported, particulate matter, gas composition, energy produced, energy consumed, raw fuel consumed, and waste stream.

The collecting means are preferably connected to at least one data source comprising relevant data related to emissions associated to the transportation means. The transportation means perform a transportation of raw material from the raw material production sites to the bioproduct production sites, as well as a delivery from the bioproduct production site. The transportation means go through routes which are selected using the route system. Preferably, the routes may be selected considering as a criterion the GHG (greenhouse gas) emissions associated to the at least one transportation means performing said route.

The relevant data may comprise at last one of the following:
data available from bibliography and/or databases comprising information related to emissions the means of transportation, and
data related to a direct use of energy consumption of the transportation means.

According to a preferred embodiment, the at least one processing unit comprises:
at least one processor adapted to execute the instructions related to the determination of GHG (greenhouse gas) emissions level in bioproduct industry, processing at least one of the following:
   the GHG (greenhouse gas) emissions data, and
   the at least one first and second variables related to GHG (greenhouse gas) emissions,
at least one memory connected to the at least one processor, and
storage means adapted to store at least the instructions executed by the at least one processor.

The data transmission means may be selected from the group consisting of: wired communication means, wireless communication means and near field communication means.

The bioproduct may preferably further comprise a co-product of bioproduct. The bioproduct may be bioethanol or biodiesel, among others.

According to a preferred embodiment, the source material may be selected from the group consisting of: cereals, sugar cane, straw, energy crops, forestry material, forestry residues, organic waste, wine alcohol, aquaculture and fishery residues and oleaginous crops.

The system may preferably further comprise at least one interface to the processing unit, adapted to output a report of the GHG (greenhouse gas) emissions level.

The GHG (greenhouse gas) emissions data associated to bioproduct industry may be preferably selected from the group consisting of:
a transport and distribution emission rate [TDER] related to GHG (greenhouse gas) emissions produced by every element involved in logistics of bioproduct industry; like transportation means, depots or filling stations. Said transport and distribution emission rate [TDER] is the result from processing the at least one first variable related to GHG (greenhouse gas) emissions produced by one or more of said elements involved in bioproduct logistics i.e. at least one transportation means,
an emission factor [EmissionFactor] resulting from processing the at least one second variable related to GHG (greenhouse gas) emissions produced by each process associated to bioproduct industry,
an activity data [ActivityData] value resulting from processing the at least one variable related to GHG (greenhouse gas) emissions produced by each process associated to bioproduct industry,
an emission value [EmissionValue] resulting from processing the emission factor along with an activity data value, and
an emission level [EmissionLevel] resulting from summing all the emission values and the transport and distribution emission rate [TDER].

### BRIEF DESCRIPTION OF THE DRAWINGS

For a better understanding of the present invention, reference will now be made, by way of example only, to the accompanying drawings in which:

FIG. 1 depicts a diagram of the system and method of the invention.

### DETAILED DESCRIPTION OF A PREFERRED EMBODIMENT

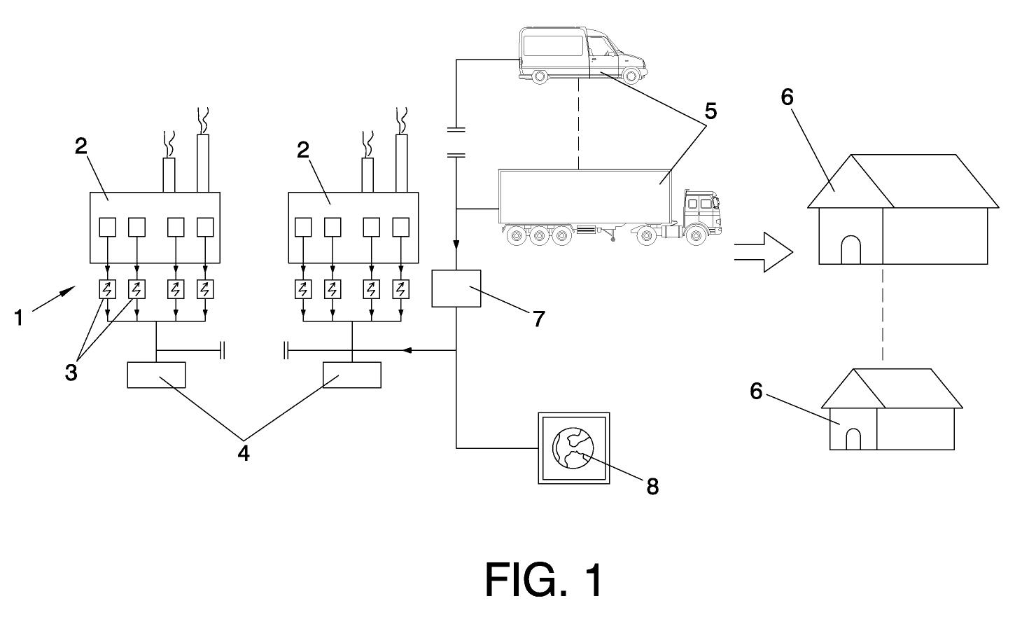

Following the reference signs adopted in FIG. 1, there now follows a more detailed description of an embodiment of the invention.

As depicted in FIG. 1, the invention describes a system and method for measuring a GHG (greenhouse gas) emissions level in bioproduct production industry.

The method of the invention starts by retrieving from a plurality of sensors (2), arranged along a bioproduct production site (7), in this case a biofuel production plant, by means of a GHG (greenhouse gas) emissions modelling module (4) using the processing unit and the data transmission means [not represented in the figures], at least one first variable related to GHG (greenhouse gas) emissions generated by transportation means (5) by means of data collecting means [not represented in the figures] and GHG (greenhouse gas) emissions data associated to each process of bioproduct production related to at least one second variable impacting GHG (greenhouse gas) emissions data resulting from bioproduct production at a bioproduct production facility In order to ease the transportation of raw material and bioproduct, the system includes at least one route system (6) for showing information relating to possible transportation routes, and allowing, on the basis of said information, the selection of one route, which is considered the optimal route according to preset criteria.

The bioproduct may further comprise a bioproduct co-product. The bioproduct may be biofuel like bioethanol or biodiesel, among others. The co-product of bioproduct may be, among others, bioliquids; chemicals; feed raw; renewable electrical energy, renewable thermal energy and CO₂.

The source material is preferably selected from the group consisting of: cereals, sugar cane, straw, energy crops, forestry material, forestry residues, organic waste, wine alcohol, aquaculture and fishery residues and oleaginous crops.

The data collecting means may preferably be connected to at least one source comprising relevant data to emissions associated to the transport means (5), as stated below.

The processing unit preferably comprises:
at least one processor adapted to execute the instructions related to the determination of GHG (greenhouse gas) emissions level in bioproduct industry, processing at least one of the following:
   the GHG (greenhouse gas) emissions data, and
   the at least one first and second variables related to GHG (greenhouse gas) emissions,
at least one memory connected to the at least one processor, and
storage means adapted to store at least the instructions executed by the at least one processor.

The data transmission means may be selected from the group consisting of: wired communication means, wireless communication means and near field communication means.

The system may further comprise at least one interface to the processing unit, adapted to output a report of the GHG (greenhouse gas) emissions level.

According to a preferred embodiment of the invention, the GHG (greenhouse gas) emissions data associated to bioproduct industry may be selected from the group consisting of:
a transport and distribution emission rate [TDER] related to GHG (greenhouse gas) emissions produced by the at least one transportation means (5) resulting from processing the at least one first variable related to GHG (greenhouse gas) emissions produced by said at least one transportation means (5),
an emission factor [EmissionFactor] resulting from processing the at least one second variable related to GHG (greenhouse gas) emissions produced by each process associated to bioproduct industry,
an activity data [ActivityData] value resulting from processing the at least one variable related to GHG (greenhouse gas) emissions produced by each process associated to bioproduct industry,
an emission value [EmissionValue] resulting from processing the emission factor along with an activity data value, and
an emission level [EmissionLevel] resulting from summing all the emission values and the transport and distribution emission rate [TDER].

The plurality of sensors may be adapted to monitor and report data selected from the group consisting of a flow rate, temperature, pressure, weight, moisture, flow composition, energy exported, particulate matter, gas composition, energy produced, energy consumed, raw fuel consumed, and waste stream.

Data sources considered for obtaining an emission factor for each one the transportation means (5) (needed for the transportation and delivery of the bioproduct), comprise data available from bibliography or databases comprising relevant data or direct use of energy (for example, but no limited to fuel) consumption as activity data and the emission factor for said specific fuel.

Some properties values are needed when the GHG (greenhouse gas) emissions data is obtained from calculation. The list of properties used may comprise biodiesel density and biodiesel Low Heat Value (LHV).

The method for measuring GHG (greenhouse gas) emissions associated to bioproduct industry of the invention using the system (1) previously described comprises the next steps:
retrieving, by means of the GHG (greenhouse gas) emissions modelling module (4), from the plurality of sensors (2), the at least one first and second variables impacting emissions of the GHG (greenhouse gas),
sending said at least one first and second variables impacting emissions of the GHG (greenhouse gas) to the database by means of the data transmission means (3),
retrieving, by means of the GHG (greenhouse gas) emissions modelling module (4), from the database said at least one first and second variable impacting emissions of the GHG (greenhouse gas),
calculating, by means of the GHG (greenhouse gas) emissions modelling module (4), the at least one transport and distribution emission rate [TDER] related to GHG (greenhouse gas) emissions produced by the at least one transportation means (5) from the at least one first variable impacting emissions of the GHG (greenhouse gas) collected by the data collecting means,
calculating, by means of the GHG (greenhouse gas) emissions modelling module (4), the activity data value from the at least one second variable impacting emissions of the GHG (greenhouse gas),
calculating, by means of the GHG (greenhouse gas) emissions modelling module (4), the emission factor from the at least one second variable impacting emissions of the GHG (greenhouse gas),
calculating, by means of the GHG (greenhouse gas) emissions modelling module (4), the emission value associated to each process using the following formula:

Emission Value=EmissionFactor·ActivityData,
and
calculating, by means of the GHG (greenhouse gas) emissions modelling module (4), the GHG (greenhouse gas) emission level associated to bioproduct industry, applying the following formula:

$$EmmissionLevel = {\sum }_{i = 1}^{n} ( {ActivityData}_{i} \cdot {EmissionsFactor}_{i} ) + {\sum }_{i = 1}^{n} ( {TDER}_{i} )$$

The at least one second variable impacting emissions of the GHG (greenhouse gas) used for calculating the Emission factor may be the same as well as different from the at least one second variable impacting emissions of the GHG (greenhouse gas) used for calculating the Activity Data.

The step of calculating, by means of the GHG (greenhouse gas) emissions modelling module (4), the at least one transport and distribution emission rate [TDER] related to GHG (greenhouse gas) emissions produced by the at least one transportation means (5) from the at least one first variable impacting emissions of the GHG (greenhouse gas) collected by the data collecting means, is performed on a basis of the route selected using the at least one route system adapted to allow selection of one route according to the GHG (greenhouse gas) emissions associated to the at least one transportation means performing said route.

The process related to bioproduct industry is preferably selected from the group consisting of: milling, mashing, cooking, liquefaction, fermentation, distillation, de-hydration, boiler, cogeneration unit, gas turbine, steam turbine, feedstock preparation, biomass pre-treatment, solid/liquid separation, gasification, cooling, gas cleaning, compression, catalysis reaction, enzymatic hydrolysis, selexol, transesterification, evaporation, mixing, drying, stripping, degumming, filtration, recovery, refining, purification, clarification, acid esterification, condensation, vents, and rectification.

The GHG (greenhouse gas) emissions are preferably expressed in g CO2 eq/MJ bioproduct, or as the case might be, in g CO2 eq/MJ co-product of bioproduct.

The at least one second variable of the GHG (greenhouse gas) used for calculating the Emission factor may be the same as well as different from at least one second variable impacting emissions of the GHG (greenhouse gas) used for calculating the Activity Data.

For the distribution of finished materials (bioproduct) transport emissions, eight different types of transport (that cover the means of transports used in retailing operations) have been selected for calculating the distribution emissions: pipelines, diesel train, electrical train, diesel barge, biodiesel barge, diesel truck, and vessel.

In yet another embodiment of the invention, the method accounts emissions derived from the production of other kinds of bioproduct, such as renewable electrical energy obtained from the raw material by a gasification process of said raw material. Gasification is the thermal conversion of the raw material used as feedstock into a gas, a synthesis gas called syngas (which as the skilled person would acknowledge is a fuel itself) said gas is then used for powering a cogeneration unit which produces renewable electrical energy (electricity) and/or renewable thermal energy (heat).

1. A system for measuring a GHG (greenhouse gas) emissions level associated to bioproduct industry characterised by comprising:
at least a processing unit adapted to at least execute instructions related to the determination of GHG (greenhouse gas) emissions level in bioproduct industry,
data collecting means adapted to collect and report at least one first variable related to GHG (greenhouse gas) emissions generated by at least one transportation means intended to deliver bioproduct and/or source material to be transformed in bioproduct,
at least one route system associated to the at least one transportation means, for showing information relating to possible transportation routes, and allowing the selection of one route, and allowing, on the basis of said information, the selection of one route, which is considered the optimal route according to preset criteria,
a plurality of sensors, arranged along a bioproduct production site, adapted to monitor, collect and report at least one second variable related to GHG (greenhouse gas) emissions generated from the production of bioproduct at said bioproduct production site,
data transmission mean adapted to transmit data and connected to the processing unit and at least to the plurality of sensors,
at least one database accessible by the processing unit by means of the data transmission means, and
a GHG (greenhouse gas) emissions modelling module connected to the processing unit and adapted to process the at least one first and second variables related to GHG (greenhouse gas) emissions, for calculating GHG (greenhouse gas) emissions data associated to each process related to bioproduct industry.

2. The system of claim 1 wherein the data regarding the at least one second variable related to GHG (greenhouse gas) emissions generated from the production of bioproduct at the production site and the at least one first variable related to GHG (greenhouse gas) emissions generated by at least one transportation mean, are included in the at least one database.

3. The system of claim 1, wherein the plurality of sensors are adapted to monitor and report data selected from the group consisting of: a flow rate, temperature, pressure, weight, moisture, flow composition, energy exported, particulate matter, gas composition, energy produced, energy consumed, raw fuel consumed, and waste stream.

4. The system of claim 1, wherein the collecting means are connected to at least one data source comprising relevant data related to emissions associated to the transportation means.

5. The system of claim 1, wherein the relevant data comprises at last one of the following:
data available from bibliography and/or databases comprising information related to emissions the transportation means, and
data related to a direct use of energy consumption of the transportation means.

6. The system of claim 1 wherein the at least one processing unit comprises:
t least one processor adapted to execute the instructions related to the determination of GHG (greenhouse gas) emissions level in bioproduct industry, processing at least one of the following:
the GHG (greenhouse gas) emissions data, and
the at least one first and second variables related to GHG (greenhouse gas) emissions,
at least one memory connected to the at least one processor, and
storage means adapted to store at least the instructions executed by the at least one processor.

7. The system of claim 1 wherein the data transmission means are selected from the group consisting of: wired communication means, wireless communication means and near field communication means.

8. The system of claim 1 wherein the bioproduct further comprises a co-product of bioproduct.

9. The system of claim 8, wherein the co-product of bioproduct is selected from the group consisting of: biofuels, bioliquids, biogas, chemicals, feed raw, renewable electrical energy, renewable thermal energy, bioplastics, resins and CO₂.

10. The system of claim 1 wherein the bioproduct is a biofuel.

11. The system of claim 10 wherein the biofuel is selected from the group consisting of: bioethanol and biodiesel.

12. The system to of claim 1 wherein the bioproduct is a bioplastic.

13. The system of claim 1 wherein the source material is selected from the group consisting of: cereals, sugar cane, straw, energy crops, forestry material, forestry residues, organic waste, wine alcohol, aquaculture and fishery residues and oleaginous crops.

14. The system of claim 1 further comprising at least one interface to the processing unit, adapted to output a report of the GHG (greenhouse gas) emissions level.

15. The system of claim 1, wherein the at least one route system is adapted to allow selection of one route according to the GHG (greenhouse gas) emissions associated to the at least one transportation means performing said route.

16. The system of claim 1, wherein the GHG (greenhouse gas) emissions data associated to bioproduct industry is selected from the group consisting of:
a transport and distribution emission rate [TDER] related to GHG (greenhouse gas) emissions produced by the at least one transportation means resulting from processing the at least one first variable related to GHG (greenhouse gas) emissions produced by said at least one transportation means,
an emission factor [EmissionFactor] resulting from processing the at least one second variable related to GHG (greenhouse gas) emissions produced by each process associated to bioproduct industry,
an activity data [ActivityData] value resulting from processing the at least one variable related to GHG (greenhouse gas) emissions produced by each process associated to bioproduct industry,
an emission value [EmissionValue] resulting from processing the emission factor along with an activity data value, and
an emission level [EmissionLevel] resulting from summing all the emission values and the transport and distribution emission rate [TDER].

17. A method for measuring GHG (greenhouse gas) emissions associated to bioproduct industry, the method comprising:
retrieving, by means of a GHG (greenhouse gas) emissions modelling module, from a plurality of sensors at least one first and second variables impacting emissions of the GHG (greenhouse gas),
sending said at least one first and second variables impacting emissions of the GHG (greenhouse gas) to a database by means of data transmission means,
retrieving, by means of the GHG (greenhouse gas) emissions modelling module, from the database said at least one first and second variable impacting emissions of the GHG (greenhouse gas),
calculating, by means of the GHG (greenhouse gas) emissions modelling module, at least one transport and distribution emission rate [TDER] related to GHG (greenhouse gas) emissions produced by the at least one transportation mean from the at least one first variable impacting emissions of the GHG (greenhouse gas) collected by the data collecting means,
calculating, by means of the GHG (greenhouse gas) emissions modelling module, an activity data value from the at least one second variable impacting emissions of the GHG (greenhouse gas),
calculating, by means of the GHG (greenhouse gas) emissions modelling module, an emission factor from the at least one second variable impacting emissions of the GHG (greenhouse gas),
calculating, by means of the GHG (greenhouse gas) emissions modelling module, an emission value associated to each process using the following formula:
Emission Value=EmissionFactor·ActivityData_{, and}
calculating, by means of the GHG (greenhouse gas) emissions modelling module, an GHG (greenhouse gas) emission level associated to bioproduct industry, applying the following formula:
$$EmmissionLevel = {\sum }_{i = 1}^{n} ( {ActivityData}_{i} \cdot {EmissionsFactor}_{i} ) + {\sum }_{i = 1}^{n} ( {TDER}_{i} )$$

18. The method of claim 17 wherein the plurality of sensors are adapted to monitor, collect and report data selected from the group consisting of a flow rate, weight, moisture, flow composition, energy exported, temperature, pressure, particulate matter, gas composition, energy produced, energy consumed, raw fuel consumed and waste stream.

19. The method of claim 17 wherein the process related to bioproduct industry is selected from the group consisting of: milling, mashing, cooking, liquefaction, fermentation, distillation de-hydration, boiler, cogeneration unit, gas turbine, steam turbine, feedstock preparation, biomass pre-treatment, solid/liquid separation, gasification, cooling, gas cleaning, compression, catalysis reaction, enzymatic hydrolisys, selexol, transesterification, evaporation, mixing, drying, stripping, degumming, filtration, recovery, refining, purification, clarification, acid esterification, condensation, vents, and rectification.

20. The method of claim 17 wherein the bioproduct further comprises a co-product of bioproduct.

21. The method of claim 20, wherein the co-product of bioproduct is selected from the list consisting of: biofuels, bioliquids, biogas, chemicals, feed raw, renewable electrical energy, renewable thermal energy, bioplastics, resins and CO₂.

22. The method of claim 17 wherein the GHG (greenhouse gas) emissions are expressed in g CO2 eq/MJ.

23. The method of claim 17 wherein the bioproduct is a biofuel.

24. Method according to claim 23 wherein the biofuel is selected from the group consisting of: bioethanol and biodiesel.

25. The method of claims 17 wherein the bioproduct is a bioplastic.

26. The method of claim 17 wherein the source material is selected from the group consisting of: cereals, sugar cane, straw, energy crops, forestry material, forestry residues, organic waste, wine alcohol, aquaculture and fishery residues and oleaginous crops.

27. The method of claim 17 wherein the at least one second variable impacting emissions of the GHG (greenhouse gas) used for calculating the Emission factor is different from at least one second variable impacting emissions of the GHG (greenhouse gas) used for calculating the Activity Data.

28. The method of claim 17 wherein the at least one second variable impacting emissions of the GHG (greenhouse gas) used for calculating the Emission factor is the same that the at least one second variable impacting emissions of the GHG (greenhouse gas) used for calculating the Activity Data.

29. The method of claim 17, wherein the step of calculating, by means of the GHG (greenhouse gas) emissions modelling module, the at least one transport and distribution emission rate [TDER] related to GHG (greenhouse gas) emissions produced by the at least one transportation means from the at least one first variable impacting emissions of the GHG (greenhouse gas) collected by the data collecting means, is performed on a basis of the route selected using the at least one route system adapted to allow selection of one route according to the GHG (greenhouse gas) emissions associated to the at least one transportation means performing said route.
